(19) United States
(12) Patent Application Publication
(10) Pub. No.: US 2014/0178240 A1
(43) Pub. Date: Jun. 26, 2014

(54) BEARING FORMING METHOD

(71) Applicant: ASIA VITAL COMPONENTS CO., LTD., New Taipei City (TW)

(72) Inventor: Wen-Hao Liu, New Taipei City (TW)

(73) Assignee: ASIA VITAL COMPONENTS CO., LTD., New Taipei City (TW)

(21) Appl. No.: 13/726,184

(22) Filed: Dec. 23, 2012

(51) Int. Cl. F16C 33/00

(52) U.S. Cl. CPC F16C 33/00
USPC 419/6; 264/122

(57) ABSTRACT

A bearing forming method in which different properties of powder materials are compressed and molded in batches and then the materials are together sintered to form an integrated porous bearing. By means of the bearing forming method, the necessary material properties of a part of the bearing are enhanced. Moreover, the material cost and the manufacturing cost are greatly lowered.

### BACKGROUND OF THE INVENTION

1. Field of the Invention

The present invention relates generally to a bearing forming method in which different properties of powder materials are specifically compressed and molded in batches to form different parts of the bearing according to the necessary structural properties of the parts of the bearing and then the materials are together sintered to form an integrated bearing.

2. Description of the Related Art

A bearing is an important component of a fan. The shaft of the rotor of the motor is rotatably fitted in the bearing, whereby the wear of the shaft of the fan can be reduced to prolong the lifetime of the fan. In the conventional bearing structures, a kind of oil-retaining bearing with self-lubricant effect is popularly installed in the bearing cup of the miniaturized motor for the shaft to rotatably fit therein. The oil-retaining bearing is made of powder material by means of pressing, molding, sintering and oil soaking. The main body of the oil-retaining bearing is porous so that when the shaft is rotated, the lubricant retained in the pores of the bearing can leak out to provide lubrication effect. The conventional oil-retaining bearing is assembled in the bearing cup by means of press fit, whereby the oil-retaining bearing can be tightly fitted in the inner circumference of the bearing cup. When pressing the oil-retaining bearing into the bearing cup, the oil-retaining bearing is radially inward contracted and deformed. The deformation of the oil-retaining bearing is slight.

However, such deformation will still cause deterioration of the rotation of the shaft of the rotor. For example, the deviation and deflection of the center of the through hole will cause noise in rotation of the shaft. Also, the deformation of the inner circumference of the oil-retaining bearing will lead to hard friction between the shaft and the oil-retaining bearing. This will also cause noise in rotation of the shaft and shorten the lifetime of the motor.

Some manufacturers mix several kinds of powder materials to manufacture the bearing. This can only adjust the properties of the bearing as a whole, while failing to specifically enhance the physical properties of different parts of the bearing.

### SUMMARY OF THE INVENTION

It is therefore a primary object of the present invention to provide a bearing forming method, which can specifically enhance the necessary material properties of different parts of the bearing.

It is a further object of the present invention to provide the above bearing forming method, which can lower the manufacturing cost of the bearing.

To achieve the above and other objects, the bearing forming method of the present invention includes steps of:

providing a first powder material and placing the first powder material into mold cavity of a first mold to compress and mold the first powder material into a first structure body;

providing a second powder material and placing the first structure body and the second powder material into mold cavity of a second mold to compress and mold the first structure body and the second powder material to achieve a second structure body combined with the first structure body; and

sintering the first and second structure bodies to form a bearing.

In the above bearing forming method, different properties of powder materials are specifically compressed and molded in batches to form different parts of the bearing according to the necessary material or mechanical properties of the parts of the bearing and then the materials are together sintered to form an integrated bearing. Accordingly, the structural properties of different parts of the bearing are enhanced and the manufacturing cost of the bearing is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of a first embodiment of the bearing forming method of the present invention;

FIG. 2 is a flow chart of a second embodiment of the bearing forming method of the present invention; and

FIG. 3 is a perspective view of the bearing made by means of the bearing forming method of the present invention.

### DETAILED DESCRIPTION OF THE PREFERRED EMBODIMENTS

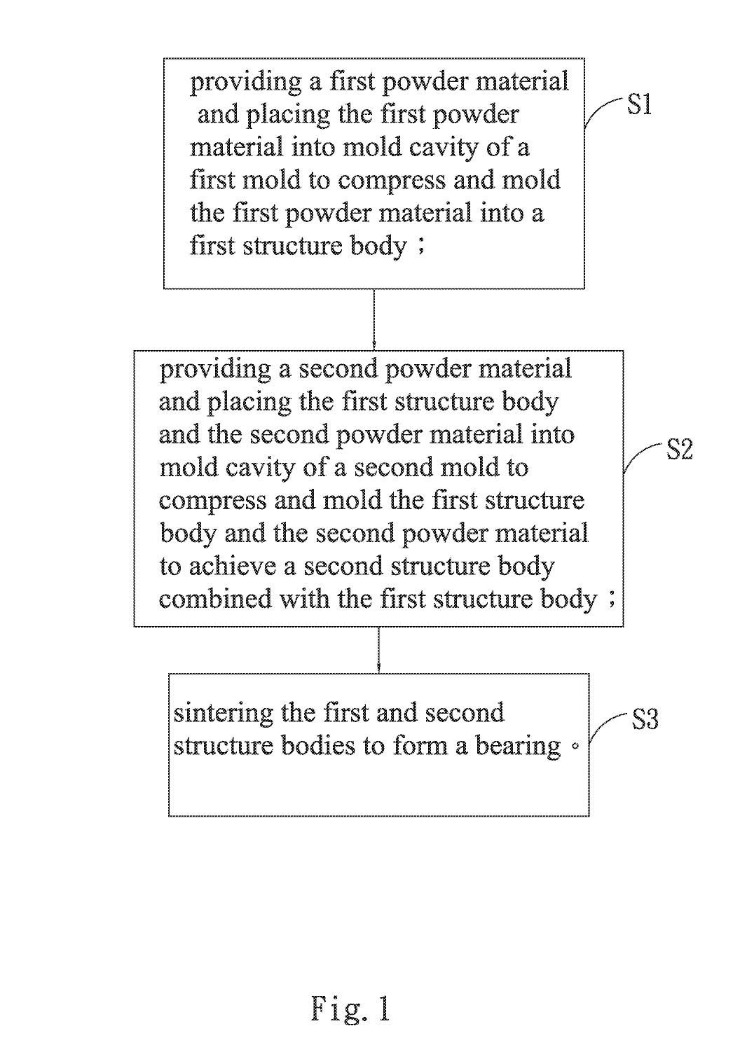

Please refer to FIG. 1, which is a flow chart of a first embodiment of the bearing forming method of the present invention. According to the first embodiment, the bearing forming method of the present invention includes:

step 51 of providing a first powder material and placing the first powder material into mold cavity of a first mold to compress and mold the first powder material into a first structure body, a first powder material and a first mold with a first mold cavity being provided, the first powder material being placed into the first mold cavity of the first mold and then compressed and molded into a first structure body in the first mold cavity of the first mold;

step S2 of providing a second powder material and placing the first structure body and the second powder material into mold cavity of a second mold to compress and mold the first structure body and the second powder material to achieve a second structure body combined with the first structure body, a second powder material and a second mold with a second mold cavity being provided, the first structure body and the second powder material being placed into the second mold cavity of the second mold and then compressed and molded into a second structure body, which is formed of the first structure body and the second powder material; and

step S3 of sintering the first and second structure bodies to form a bearing, the first and second structure bodies being sintered at the same time, whereby after sintered, the first and second structure bodies themselves are molten and solidified and associated with each other to form a bearing.

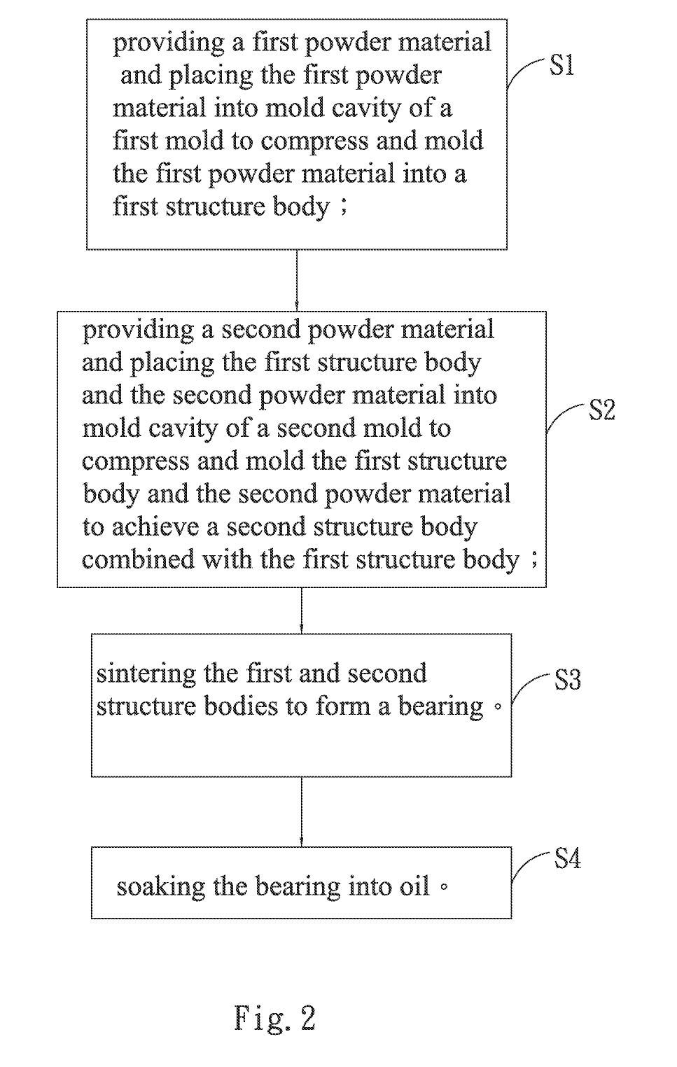

Please refer to FIG. 2, which is a flow chart of a second embodiment of the bearing forming method of the present invention. According to the second embodiment, the bearing forming method of the present invention includes:

step S1 of providing a first powder material and placing the first powder material into mold cavity of a first mold to compress and mold the first powder material into a first structure body;

step S2 of providing a second powder material and placing the first structure body and the second powder material into mold cavity of a second mold to compress and mold the first structure body and the second powder material to achieve a second structure body combined with the first structure body; and

step S3 of sintering the first and second structure bodies to form a bearing.

The second embodiment is partially identical to the first embodiment in step and thus will not be repeatedly described. The second embodiment is different from the first embodiment in that the second embodiment further includes a step S4 of soaking the bearing into oil after step S3 of sintering the first and second structure bodies to form a bearing.

The sintered bearing is soaked into oil. The first and second structure bodies are porous structure bodies. Therefore, when soaked in the oil, under capillarity, the oil is absorbed and stored in the pores of the first and second structure bodies. In this case, in use, the bearing is self-lubricant and it is unnecessary to add any lubricant to the bearing.

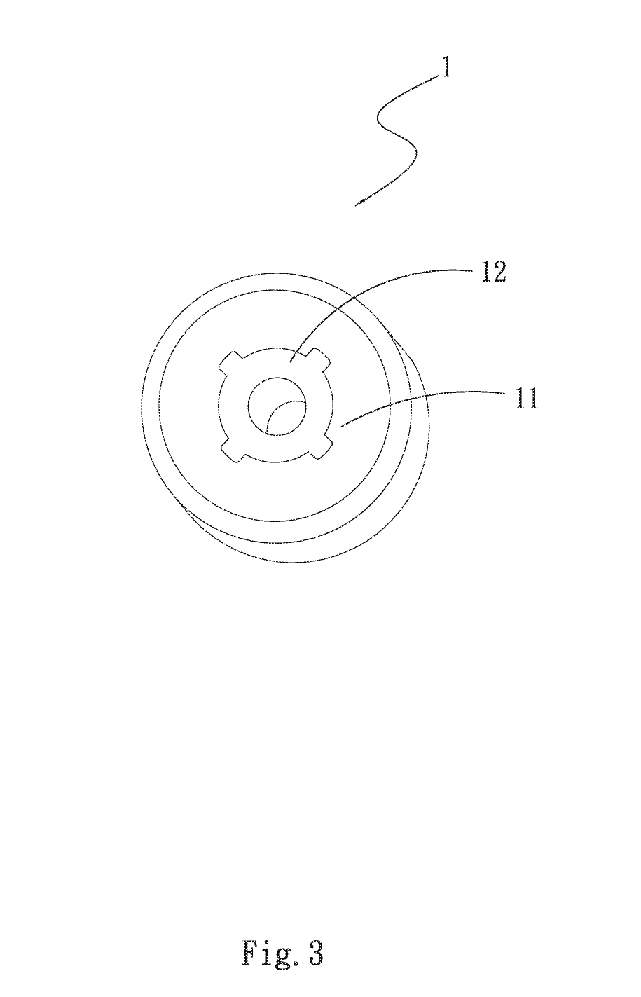

Please now refer to FIG. 3, which is a perspective view of the bearing made by means of the bearing forming method of the present invention. The bearing 1 is composed of the first structure body 11 and the second structure body 12. The first structure body 11 serves as a main structure and needs to have better structural strength. Therefore, the powder material selected for molding the first structure body 11 is a powder material higher hardness. The second structure body 12 of the bearing 1 is positioned in a position where a shaft (not shown) and the bearing 1 abrade each other. Therefore, the powder material selected for molding the second structure body 12 is an antiwear powder material. After the first and second structure bodies 11, 12 are compressed and sintered, the first structure body 11 will have a hardness higher than that of the second structure body 12, while the second structure body 12 will have an antiwear performance better than that of the first structure body 11. The antiwear powder material of the second structure body 12 is selected from a group consisting of nickel, chrome, molybdenum, tungsten and ceramic powder.

The bearing 1 is a sintered structure so that the first and second structure bodies 11, 12 are porous structure bodies.

By means of the bearing forming method of the present invention, the mechanical properties such as antiwear performance and hardness of a part of the bearing are enhanced. Moreover, the material cost is greatly lowered to save manufacturing cost.

The present invention has been described with the above embodiments thereof and it is understood that many changes and modifications in the above embodiments can be carried out without departing from the scope and the spirit of the invention that is intended to be limited only by the appended claims.

What is claimed is:

1. A bearing forming method comprising steps of:
providing a first powder material and placing the first powder material into mold cavity of a first mold to compress and mold the first powder material into a first structure body;
providing a second powder material and placing the first structure body and the second powder material into mold cavity of a second mold to compress and mold the first structure body and the second powder material to achieve a second structure body combined with the first structure body; and
sintering the first and second structure bodies to form a bearing.

2. The bearing forming method as claimed in claim 1, wherein the first structure body has a hardness higher than that of the second structure body.

3. The bearing forming method as claimed in claim 1, wherein the second structure body has an antiwear performance better than that of the first structure body.

4. The bearing forming method as claimed in claim 1, wherein the second structure body is made from an antiwear material.

5. The bearing forming method as claimed in claim 4, wherein the antiwear material of the second structure body is selected from a group consisting of nickel, chrome, molybdenum, tungsten and ceramic powder.

6. The bearing forming method as claimed in claim 1, further comprising a step of soaking the bearing into oil after the step of sintering the first and second structure bodies to form the bearing.

7. The bearing forming method as claimed in claim 1, wherein the first and second structure bodies are porous structure bodies.
